(19) United States
(12) Patent Application Publication
(10) Pub. No.: US 2019/0382320 A1
(43) Pub. Date: Dec. 19, 2019

(54) ENHANCED STABILITY OF UREASE INHIBITOR-CONTAINING COMPOSITIONS

(71) Applicant: Koch Agronomic Services, LLC, Wichita, KS (US)

(72) Inventors: Ethel Garnier, Wichita, KS (US); Douglas Barr, Wichita, KS (US)

(21) Appl. No.: 16/479,084

(22) PCT Filed: Jan. 17, 2018
(86) PCT No.: PCT/IB2018/050295

§ 371 Date: Jul. 18, 2019

Related U.S. Application Data
(60) Provisional application No. 62/448,125, filed on Jan. 19, 2017.

(51) Int. Cl. C05G 3/08; C05C 9/02

(52) U.S. Cl. CPC C05G 3/08; C05C 9/02

(57) ABSTRACT

Methods for enhancing the stability of urease inhibitors and urease inhibitor-containing compositions and for reducing the rate of degradation of urease inhibitors and urease inhibitor-containing compositions are provided. Such methods generally involve providing the urease inhibitor in the form of one or more adducts of the urease inhibitor with urea, an aldehyde, or both urea and the aldehyde.

### FIELD OF THE DISCLOSURE

The present subject matter relates generally to methods for enhancing the stability of urease inhibitors and compositions containing urease inhibitors.

### BACKGROUND

Fertilizers have been used for some time to provide nitrogen to the soil. The most widely used and agriculturally important nitrogen fertilizer is urea, CO(NH₂)₂. Most of the urea currently produced is used as a fertilizer in its granular (or prilled) form. After application of urea to soil, it is readily hydrolyzed to yield ammonia and carbon dioxide. This process is catalyzed by the enzyme urease, which is produced by some bacteria and fungi that may be present in the soil. The gaseous products formed by the hydrolysis reaction (i.e., ammonia and carbon dioxide) can volatilize to the atmosphere and thus, substantial losses from the total amount of the nitrogen applied to the soil can occur.

Attempts to reduce losses of applied nitrogen have utilized urease inhibitors and/or nitrification inhibitors as additives to the fertilizer. Urease inhibitors are compounds capable of inhibiting the catalytic activity of the urease enzyme on urea in the soil. Nitrification inhibitors are compounds capable of inhibiting the bacterial oxidation of ammonium to nitrate in the soil. Urease inhibitors and nitrification inhibitors can be associated with fertilizers in various ways. For example, they can be coated onto fertilizer granules or mixed into fertilizer matrices. A number of granulation methods are known, including falling curtain, spherudization-agglomeration drum granulation, prilling and fluid bed granulation technologies.

Examples of urease inhibitors are the thiophosphoric triamide compounds disclosed in U.S. Pat. No. 4,530,714 to Kolc et al., which is incorporated herein by reference. The disclosed thiophosphoric triamide compounds include N-(n-butyl) thiophosphoric triamide (NBPT), the most developed representative of this class of compounds. When incorporated into a urea-containing fertilizer, NBPT reduces the rate at which urea is hydrolyzed in the soil to ammonia. The benefits realized as a result of the delayed urea hydrolysis include the following: (1) nutrient nitrogen is available to the plant over a longer period of time; (2) excessive build-up of ammonia in the soil following the application of the urea-containing fertilizer is avoided; (3) the potential for nitrogen loss through ammonia volatilization is reduced; (4) the potential for damage by high levels of ammonia to seedlings and young plants is reduced; (5) plant uptake of nitrogen is increased; and (6) an increase in crop yields is attained. NBPT is commercially available for use in agriculture and is marketed in such products as the AGROTAIN® nitrogen stabilizer product line.

Industrial grade NBPT is a solid, waxy compound, and decomposes by the action of water, acid and/or elevated temperature. In particular, NBPT is believed to degrade at elevated temperatures into compounds that may not provide the desired inhibitory effects on the urease enzyme. Accordingly, its combination with other solid materials to provide a material capable of inhibiting urease, particularly via granulation with urea (which generally employs heat) can be challenging. Further, NBPT and compositions comprising NBPT are reasonably stable under normal storage conditions (such as room temperature and neutral pH), but it is known that acidic conditions may lead to rapid disappearance of NBPT. See, for example, Engel et al., Apparent persistence of N-(N-butyl) thiophosphoric triamide is greater in alkaline soils, Soil Science Society of America Journal 77(4), 1424-1429 (2013). Certain techniques have been pursued to slow the degradation of NBPT, but have shown limited efficacy. As such, there is a need for methods and compositions wherein the stability of NBPT, particularly under acidic conditions, is enhanced.

### SUMMARY OF THE INVENTION

As disclosed herein, methods for enhancing the stability of urease inhibitors and compositions comprising urease inhibitors are provided. Such methods generally comprise providing the urease inhibitor, at least in part, in the form of a reaction product between the urease inhibitor (e.g., N-(n-butyl) thiophosphoric triamide, NBPT) and/or urea and/or an aldehyde. The reaction product generally comprises one or more structurally different adducts of the urease inhibitor with urea and/or the aldehyde (referred to herein as urease inhibitor adducts). Such adduct forms, as will be further described and demonstrated herein, can effectively serve to “protect” the urease inhibitor from certain routes of degradation, enhancing the stability of the urease inhibitor (and compositions containing the urease inhibitor) over time.

In one aspect of the invention, a method for enhancing the stability of a urease inhibitor is provided, comprising providing the urease inhibitor in the form of one or more adducts of the urease inhibitor with urea, formaldehyde, or both urea and formaldehyde. In another aspect of the invention, a method for reducing the rate of degradation of a urease inhibitor is provided, comprising providing the urease inhibitor in the form of one or more adducts of the urease inhibitor with urea, formaldehyde, or both urea and formaldehyde.

In some embodiments, such methods further comprise combining a nitrogen source with the one or more adducts to give a fertilizer composition and applying the fertilizer composition to soil, wherein the fertilizer composition exhibits slower degradation of the urease inhibitor than a comparable fertilizer composition comprising the urease inhibitor, urea, and formaldehyde in free form. The nitrogen source can be selected from the group consisting of solid urea, urea ammonium nitrate, and urea formaldehyde polymer. Such fertilizer compositions can, in some embodiments, comprise about 90% by weight or more urea, about 98% by weight or more urea, or about 99% or more by weight urea. Fertilizer compositions can comprise various additional components, e.g., one or more materials selected from the group consisting of free urease inhibitor, free formaldehyde, formaldehyde equivalents, urea formaldehyde polymer (UFP), water, and combinations thereof. In certain embodiments, the fertilizer composition comprises substantially no dicyandiamide.

In some embodiments, the disclosed methods for enhancing the stability and/or reducing the rate of degradation of urease inhibitors further comprise applying the one or more adducts to soil following application of a nitrogen source to the soil. In some embodiments, the disclosed methods for enhancing the stability and/or reducing the rate of degradation of urease inhibitors further comprise applying the one or more adducts to soil prior to application of a nitrogen source to the soil. Although the methods disclosed herein are understood to be applicable to various soils, in some embodiments, the soil to which the one or more urease inhibitor adducts are applied is acidic.

The disclosure further provides a method of preparing a urease inhibitor-containing composition wherein the urease inhibitor exhibits enhanced stability, comprising: combining a urease inhibitor, urea, and formaldehyde to form an adduct of the urease inhibitor with urea, formaldehyde, or both urea and formaldehyde. The disclosure additionally provides a method of preparing a urease inhibitor-containing composition wherein the urease inhibitor exhibits a reduced rate of degradation, comprising: combining a urease inhibitor, urea, and formaldehyde to form an adduct of the urease inhibitor with urea, formaldehyde, or both urea and formaldehyde.

The methods disclosed herein are believed to be applicable across a range of urease inhibitors. However, in certain specific embodiments, the urease inhibitor is N-(n-butyl)thiophosphoric triamide (NBPT). The structures of the adduct or adducts involved in the disclosed methods can vary. In some embodiments, the one or more adducts comprise one or more adducts represented by the following:

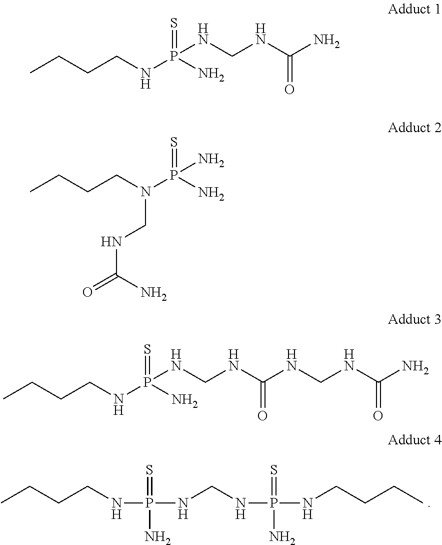 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]

### BRIEF DESCRIPTION OF THE DRAWINGS

In order to provide an understanding of embodiments of the invention, reference is made to the appended figures. These figures are exemplary only, and should not be construed as limiting the invention.

FIG. 1A is a plot of the amount of NBPT in adduct form and NBPT in free form present in an NBPT adduct-containing composition over a period of four days at a pH of 4; and

FIG. 1B is a plot of the data of FIG. 1A, with the amount of NBPT in adduct form and amount of NBPT in free form separately plotted;

FIG. 2A is a plot of the amount of NBPT in adduct form and NBPT in free form present in an NBPT adduct-containing composition over a period of four days at a pH of 7; and

FIG. 2B is a plot of the data of FIG. 1A, with the amount of NBPT in adduct form and amount of NBPT in free form separately plotted;

FIG. 3A is a plot of the amount of NBPT in adduct form and NBPT in free form present in an NBPT adduct-containing composition over a period of four days at a pH of 9; and

FIG. 4B is a plot of the data of FIG. 1A, with the amount of NBPT in adduct form and amount of NBPT in free form separately plotted; and

FIG. 5 is a plot of the pH fluctuation of each sample over this period of four days.

### DETAILED DESCRIPTION OF THE INVENTION

It is noted here that as used in this specification and the appended claims, the singular forms “a,” “an,” and “the” include plural reference unless the context clearly dictates otherwise. All percentages, parts and ratios are based upon the total weight of the compositions of the present invention, unless otherwise specified. All such weights as they pertain to listed ingredients are based on the active level and, therefore do not include solvents or by-products that may be included in commercially available materials, unless otherwise specified. The term “weight percent” may be denoted as “wt. %” herein. All molecular weights as used herein are weight average molecular weights expressed as grams/mole, unless otherwise specified.

It is known that, in compositions comprising urease inhibitors such as N-(n-butyl)thiophosphoric triamide (NBPT), the concentration of the urease inhibitor decreases over time due to degradation of the urease inhibitor, particularly under acidic conditions (i.e., at a pH of less than 7). Studies have found, in particular, that NBPT degradation exhibits pseudo first-order rate kinetics in chemical buffers and exponential decay patterns in soil. Although not intended to be limiting, it is believed that one primary route of degradation of NBPT, leading to this decrease in urease inhibitor concentration, involves hydrolysis to produce n-butylamine and a P-containing byproduct (—OP(S)NH₂)₂). See Engel et al., Abstract, Soil pH Affects Degradation of the Urease Inhibitor NBPT, Synergy in Science: Partnering for Solutions, 2015 Annual Meeting 2015 and Engel et al. Degradation of the urease inhibitor NBPT as affected by soil pH. Soil Sci. Soc. Am. J. 79(6): (2015).

The present disclosure describes a strategy for enhancing stability of urease inhibitors by “protecting” such urease inhibitor from degradation (e.g., from hydrolysis), particularly under acidic conditions, although not limited thereto. According to the present disclosure, it has been recognized that compositions comprising urease inhibitors in the form of urease inhibitor-containing adducts with urea and/or aldehydes (as will be detailed more thoroughly herein below) exhibit enhanced stability, i.e., slower degradation of the urease inhibitor and/or a lower overall loss of the urease inhibitor from such compositions.

### Urease Inhibitor Adducts and Preparation Thereof

“Urease inhibitor adduct” as used herein refers to a reaction product resulting from reaction between one or more urease inhibitors and urea and/or an aldehyde. Such reaction products (comprising one or more structurally different adducts) retain at least portions of two or more of the reactants (i.e., urease inhibitor, urea, and/or aldehyde). Some urease inhibitor adducts are disclosed in U.S. patent application Ser. No. 15/349,512, filed Nov. 11, 2016, which is incorporated by reference herein in its entirety. One exemplary urease inhibitor adduct, which is not intended to be limiting, is an adduct formed from N-(n-butyl)thiophosphoric triamide (NBPT), and urea and/or an aldehyde (e.g., formaldehyde). Urease inhibitor adducts can be provided as-formed, can be purified to isolate one or more components therefrom, or can be provided in combination with one or more other components, such as additional urease inhibitor or a fertilizer composition, e.g., in the form of a nitrogen source including, but not limited to, a urea source.

A “urease inhibitor” that can be incorporated within the adducts is any compound that reduces, inhibits, or otherwise slows down the conversion of urea to ammonium (NH₄⁺) in soil. Exemplary urease inhibitors include thiophosphoric triamides and phosphoric triamides of the general formula (I)

X═P(NH₂)₂NR¹R² (I)

where X═oxygen or sulfur, and R¹ and R² are independently selected from hydrogen, C₁-C₁₂ alkyl, C₃-C₁₂ cycloalkyl, C₆-C₁₄ aryl, C₂-C₁₂ alkenyl, C₂-C₁₂ alkynyl, C₅-C₁₄ heteroaryl, C₁-C₁₄ heteroalkyl, C₂-C₁₄ heteroalkenyl, C₂-C₁₄ heteroalkynyl, or C₃-C₁₂ cycloheteroalkyl groups.

In certain embodiments, urease inhibitors are N-(alkyl) thiophosphoric triamide urease inhibitors as described in U.S. Pat. No. 4,530,714 to Kolc et al., which is incorporated herein by reference in its entirety. Particular illustrative urease inhibitors can include, but are not limited to, N-(n-butyl)thiophosphoric triamide, N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene, thiopyridines, thiopyrimidines, thiopyridine-N-oxides, N,N-dihalo-2-imidazolidinone, N-halo-2-oxazolidinone, derivatives thereof, or any combination thereof. Other examples of urease inhibitors include phenylphosphorodiamidate (PPD/PPDA), hydroquinone, N-(2-nitrophenyl) phosphoric acid triamide (2-NPT), ammonium thiosulphate (ATS) and organo-phosphorous analogs of urea, which are effective inhibitors of urease activity (see e.g. Kiss and Simihaian, Improving Efficiency of Urea Fertilizers by Inhibition of Soil Urease Activity. Kluwer Academic Publishers, Dordrecht, The Netherlands, 2002; Watson, Urease inhibitors. IFA International Workshop on Enhanced-Efficiency Fertilizers, Frankfurt. International Fertilizer Industry Association, Paris, France 2005).

In particular embodiments, the urease inhibitor can be or can include N-(n-butyl) thiophosphoric triamide (NBPT). The preparation of phosphoramide urease inhibitors such as NBPT can be accomplished, for example, by known methods starting from thiophosphoryl chloride, primary or secondary amines and ammonia, as described, for example, in U.S. Pat. No. 5,770,771, which is incorporated herein by reference. In a first step, thiophosphoryl chloride is reacted with one equivalent of a primary or secondary amine in the presence of a base, and the product is subsequently reacted with an excess of ammonia to give the end product. Other methods include those described in U.S. Pat. No. 8,075,659 to Wissemeier et al., which is incorporated herein by reference, where thiophosphoryl chloride is reacted with a primary and/or secondary amine and subsequently with ammonia. However this method can result in mixtures. Accordingly, when N-(n-butyl)thiophosphoric triamide (NBPT) or other urease inhibitors are used, it should be understood that this refers not only to the urease inhibitor in its pure form, but also to various commercial/industrial grades of the compound, which can contain up to 50 percent (or less), preferably not more than 20 percent, of impurities, depending on the method of synthesis and purification scheme(s), if any, employed in the production thereof. Combinations of urease inhibitors, for example using mixtures of NBPT and other alkyl-substituted thiophosphoric triamides, are known.

Representative grades of urease inhibitor may contain up to about 50 wt. %, about 40% about 30%, about 20% about 19 wt. %, about 18 wt. %, about 17 wt. %, about 16 wt. %, about 15 wt. %, about 14 wt. %, about 13 wt. %, about 12 wt. %, about 11 wt. %, 10 wt. %, about 9 wt. %, about 8 wt. %, about 7 wt. %, about 6 wt. % about 5 wt. %, about 4 wt. %, about 3 wt. %, about 2 wt. %, or about 1 wt. % impurities, depending on the method of synthesis and purification scheme(s), if any, employed in the production of the urease inhibitor. A typical impurity in NBPT is PO(NH₂)₃ which can catalyze the decomposition of NBPT under aqueous conditions. Thus in some embodiments, the urease inhibitor used is about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, or about 99.9% pure.

For simplicity, the invention may be described in relation to embodiments wherein NBPT is the urease inhibitor. Description of the invention in terms wherein NBPT is the urease inhibitor should not be viewed as necessarily excluding the use of other urease inhibitors, or combinations of urease inhibitors, unless expressly noted.

The urea used to produce urease inhibitor adducts can be in various forms. For example, the urea can be a solid in the form of prills, flakes, granules, and the like, and/or a solution, such as an aqueous solution, and/or in the form of molten urea. At least a portion of the urea can be in the form of animal waste. Both urea and combined urea-formaldehyde products can be used according to the present disclosure. Illustrative urea-formaldehyde products can include, but are not limited to, urea-formaldehyde concentrate (“UFC”) and urea-formaldehyde polymers (“UFP”). These types of products can be as discussed and described in U.S. Pat. Nos. 5,362,842 and 5,389,716 to Graves et al., for example, which are incorporated herein by reference. Any form of urea or urea in combination with formaldehyde can be used to make a UFP. Examples of solid UFP include PERGOPAK M® 2, available from Albemarle Corporation and NITAMIN 36S, available from Koch Agronomic Services, LLC. Any of these urea sources can be used alone or in any combination to prepare the reaction product disclosed herein.

Aldehydes that can, in some embodiments, be used as a reagent in forming the adducts described herein can vary. For example, such aldehydes include, but are not limited to, formaldehyde, acetaldehyde, propionaldehyde, butyraldehyde, isobutyraldehyde, 2-methyl butanal, 2-ethyl butanal, pentanal, benzaldehyde, furfural, and analogues thereof. Aldehydes include, in some embodiments, dialdehydes, including but not limited to, glyoxal, malondialdehyde, succindialdehyde, glutaraldehyde, and analogues thereof. The aldehyde can optionally be provided in combination with urea (e.g., in the form of a mixture or polymer with urea). In some such embodiments, formaldehyde is used, and additional formaldehyde need not be added to form the desired adduct, although the disclosure is not limited thereto and it is possible to add additional formaldehyde (and/or another type of aldehyde) to such urea-formaldehyde products. Accordingly, although aldehydes, including formaldehyde, are described herein as a separate, independent reagent to produce certain adducts disclosed herein, it is noted that in certain embodiments, formaldehyde (or formaldehyde equivalents) incorporated within the adduct may be already present within the urea source (i.e., formaldehyde is not intentionally added to the reaction).

Where the aldehyde is intentionally added as a reagent to prepare adducts disclosed herein, the aldehyde can be in various forms. For example, where the added aldehyde comprises formaldehyde, the formaldehyde can be provided in the form of paraform (solid, polymerized formaldehyde) and/or formalin solutions (aqueous solutions of formaldehyde, sometimes with methanol, in about 10 wt. %, about 20 wt. %, about 37 wt. %, about 40 wt. %, or about 50 wt. %, based on the weight of the formalin solution) are commonly used forms of formaldehyde. In some embodiments, the formaldehyde can be an aqueous solution having a concentration of formaldehyde ranging from about 10 wt. % to about 50 wt. % based on total weight of the aqueous solution. Formaldehyde gas can also be used. Formaldehyde substituted in part or in whole with substituted aldehydes such as acetaldehyde and/or propylaldehyde can also be used as the source of formaldehyde. Any of these forms of formaldehyde sources can be used alone or in any combination to prepare certain adducts described herein.

Urease inhibitor adducts can be produced in various ways. Generally, the urease inhibitor is combined with, mixed, or otherwise contacted with urea and/or an aldehyde. For example, an adduct can be produced by combining a urease inhibitor with urea and/or an aldehyde such that at least one adduct is formed. For example, at least a portion of the urease inhibitor can react with at least a portion of the urea and/or at least a portion of the aldehyde to form one or more structurally different adducts, as will be described further hereinafter.

The reactants (i.e., the urease inhibitor and urea and/or aldehyde) can be combined with one another in any order or sequence. For example, in one embodiment, urea and the aldehyde are first combined and a urease inhibitor is added thereto. In another embodiment, urea and a urea formaldehyde product (e.g., urea formaldehyde concentrate or urea-formaldehyde polymer) are combined and the urease inhibitor is added thereto. In a further embodiment, a urea formaldehyde product and an aldehyde are combined and the urease inhibitor is added thereto. In a still further embodiment, urea and the urease inhibitor are combined and an aldehyde or a urea formaldehyde product is added thereto. In certain embodiments, other components can be included at any of these stages, alone, or in combination with the urea, the aldehyde, and/or the urease inhibitor. For example, in some embodiments, a nitrification inhibitor (such as those disclosed herein below) can be combined with one or more of the components, e.g., including but not limited to, embodiments wherein the nitrification inhibitor is combined with the urease inhibitor and this mixture is combined with the other components.

In these various embodiments, the form of the urease inhibitor added can vary. For example, the urease inhibitor can be used in molten liquid form, in solution form, or in suspension/dispersion form. Similarly, the form of the material with which the urease inhibitor is combined (i.e., the urea/aldehyde mixture, the urea/urea formaldehyde product mixture, or the urea formaldehyde product/aldehyde mixture) can vary. For example, in some embodiments, the material with which the urease inhibitor is combined can be in solution form, can be in dispersion/suspension form, or can be in the form of a molten urea liquid. In any case, the form of the urease inhibitor, urea, and aldehyde should allow for a high degree of contact between these reagents to facilitation the reaction and formation of adducts.

Where solvents are used at any stage of the combining process to form adducts as disclosed herein, the solvents employed are generally those sufficient to solubilize one or more of the urease inhibitor, urea, and/or aldehyde. Suitable solvents can include, for example, water (including aqueous buffers), N-alkyl 2-pyrrolidones (e.g., N-methyl-2-pyrrolidone), glycols and glycol derivatives, ethyl acetate, acetonitrile, propylene glycol, benzyl alcohol, and combinations thereof. Representative solvents known to solubilize NBPT include, but are not limited to, those solvents described in U.S. Pat. Nos. 5,352,265 and 5,364,438 to Weston, U.S. Pat. No. 5,698,003 to Omilinsky et al., U.S. Pat. Nos. 8,048,189 and 8,888,886 to Whitehurst et al., International Application Publication Nos. WO2014/100561 to Ortiz-Suarez et al., WO2014/055132 to McNight et al., WO2014/028775 and WO2014/028767 to Gabrielson et al., and EP2032589 to Cigler, which are incorporated herein by reference in their entireties. In certain embodiments, the solvent, or mixture of solvents, employed to combine the components can be selected from the group consisting of water (including buffered solutions, e.g., phosphate buffered solutions), glycols (e.g., propylene glycol), glycol derivatives and protected glycols (e.g., glycerol including protected glycerols such as isopropylidine glycerol, glycol ethers e.g. monoalkyl glycol ethers, dialkyl glycol ethers), acetonitrile, DMSO, alkanolamines (e.g., triethanolamine, diethanolamine, monoethanolamine, alkyldiethanolamines, dialkylmonoethanolamines, wherein the alkyl group can consist of methyl, ethyl, propyl, or any branched or unbranched alkyl chain), alkylsulfones (e.g., sulfolane), alkyl amides (e.g., N-2-methylpyrrolidone, N-2-ethylpyrrolidone, N,N-dimethylformamide, or any non-cyclic amide), monoalcohols (e.g., methanol, ethanol, propanol, isopropanol, benzyl alcohol), dibasic esters and derivatives thereof, alkylene carbonates (e.g., ethylene carbonate, propylene carbonate), monobasic esters (e.g., ethyl lactate, ethyl acetate), carboxylic acids (e.g., maleic acid, oleic acid, itaconic acid, acrylic acid, methacrylic acid), glycol esters, and/or surfactants (e.g. alkylbenzenesulfonates, lignin sulfonates, alkylphenol ethoxylates, polyalkoxylated amines) and combinations thereof. Further co-solvents, including but not limited to, liquid amides, 2-pyrrolidone, N-alkyl-2-pyrrolidones, and non-ionic surfactants (e.g., alkylaryl polyether alcohols) can be used in certain embodiments.

Various other additives that do not negatively impact the formation of the adducts disclosed herein can be included in the reaction mixture to form the adducts (i.e., urease inhibitor(s), urea, aldehyde, and optional solvent(s)). For example, components (e.g., impurities) that are generally present in urea and/or the aldehyde are commonly incorporated in the reaction mixture. In some embodiments, components that are desirably included in the final product can be incorporated into the reaction mixture (e.g., dyes, as described in further detail below).

In certain embodiments, monoammonium phosphate (MAP), diammonium phosphate (DAP), and/or ammonium sulfate (AMS) can be used to promote the formation of adducts. Although not intended to be limiting, it is believed that MAP, DAP, or AMS can function as catalysts to facilitate the formation of adducts disclosed herein. In some embodiments, it may be possible, by including MAP, DAP, and/or AMS (and/or other catalysts), to reduce the reaction time and/or to conduct the reaction at lower temperatures than would otherwise be required to form the adducts. In certain embodiments, mixing granules of urease inhibitor-treated urea with granules of MAP, DAP or AMS also accelerates formation of certain adducts disclosed herein as compared with embodiments wherein no catalyst is employed. In some embodiments, the use of a particular catalyst may have an effect on the amount and/or type(s) of various adducts formed during the reaction.

Adduct formation can be conducted at various pH values, and in some embodiments, it may be desirable to adjust the pH of the reaction mixture (e.g., by adding acid and/or base). Representative acids include, but are not limited to, solutions of mineral acids such as hydrochloric acid, sulfuric acid, nitric acid, phosphoric acid, and combinations thereof. Exemplary bases include, but are not limited to, solutions of ammonia, amines (e.g., primary, secondary and tertiary amines and polyamines), sodium hydroxide, potassium hydroxide, and combinations thereof. In some embodiments, it may be desirable to employ a buffer solution to control the pH of the reaction mixture. Representative buffer solutions include, but are not limited to, solutions of triethanolamine, sodium borate, potassium bicarbonate, sodium carbonate, and combinations thereof.

The conditions under which the urease inhibitor, urea, and aldehyde (and optionally, other additives) are combined can vary. For example, the reaction can be conducted at various temperatures, e.g., ranging from ambient temperature (about 25° C.) to elevated temperatures (above 25° C.). In certain embodiments, the temperature at which the reaction is conducted is at least about 50° C., at least about 60° C., at least about 70° C., at least about 80° C., at least about 90° C., or at least about 100° C., such as about 20° C. to about 150° C.

Advantageously, in some embodiments, the reaction product can be prepared under conditions of conventional urea manufacturing (as described, for example, in Jozeef Meesen, Ullman's Encyclopedia of Industrial Chemistry (2012), vol. 37, pages 657-695, which is incorporated herein by reference). Such urea manufacturing conditions generally include temperatures at which urea is in molten form, e.g., temperatures of about 130° C. to about 135° C. For example, in such embodiments, the urease inhibitor can be added to a molten mixture of urea and an aldehyde (or urea and urea-formaldehyde (i.e., UF, UFC or UFP)). The mixture can be combined and then cooled to provide a reaction product comprising the reaction product, i.e., one or more adducts of urease inhibitor and urea and/or aldehyde. For example, the composition can be cooled by subjecting the reaction mixture to typical urea pastillation, prilling or granulation processes (e.g., fluidized bed granulation, drum granulation, sprouted bed granulation, and the like), which generally comprise a cooling step following formation of pastilles, prills and/or granules. Generally, the drying process provides the reaction product in the form of a solid material (e.g., a pastillated, granular or prilled solid).

The urease inhibitor, urea, and aldehyde (i.e., the reaction mixture) can be maintained together under the reaction conditions for various periods of time. For example, in some embodiments, the reaction can be conducted within a relatively short period (e.g., on the order of minutes, e.g., about 30 seconds to about 30 minutes, about 1 to about 20 minutes, or about 1 to about 10 minutes. In some embodiments, the reaction may be conducted for about 1 minute or longer, about 2 minutes or longer, about 5 minutes or longer, about 10 minutes or longer, about 15 minutes or longer, or about 20 minutes or longer. In certain embodiments, the reaction can be conducted for about 2 hours or less, about 1 hour or less, about 30 minutes or less, about 25 minutes or less, about 20 minutes or less, about 15 minutes or less, or about 10 minutes or less. In some embodiments, the components can be reacted together for a somewhat longer period, e.g., for a period of about 2 hours or longer, about 4 hours or longer, about 6 hours or longer, about 8 hours or longer, about 10 hours or longer, about 12 hours or longer, about 14 hours or longer, about 16 hours or longer, about 18 hours or longer, about 20 hours or longer, about 22 hours or longer, or about 24 hours or longer. In some embodiments, the reaction time is about 2 hours to about 48 hours, such as about 4 hours to about 36 hours.

In certain embodiments, the amount of time for which the reaction is conducted may be that amount of time required to convert a given percentage of urease inhibitor in the reaction mixture to adduct form. For example, in one embodiment, the reaction mixture is reacted to about 10% or less free (i.e., unreacted) urease inhibitor by weight, based on total urease inhibitor added to the reaction mixture or to about 5% or less free urease inhibitor by weight, based on total urease inhibitor added to the reaction mixture. In another embodiment, the reaction mixture is reacted to about 40% or less free (i.e. unreacted) urease inhibitor by weight, based on the total urease inhibitor added to the reaction mixture, or to about 30% or less free urease inhibitor by weight, based on total urease inhibitor added to the reaction mixture, or to about 20% or less free urease inhibitor by weight, based on total urease inhibitor added to the reaction mixture. In yet another embodiment, the reaction mixture is reacted to about 2% or less free urease inhibitor by weight, based on total urease inhibitor added to the reaction mixture, or to about 1% or less free urease inhibitor by weight, based on total urease inhibitor added to the reaction mixture, or to about 0.1% or less free urease inhibitor by weight, based on total urease inhibitor added to the reaction mixture. In a further embodiment, the reaction mixture is reacted to about 50% (i.e. unreacted) urease inhibitor by weight, based on the total urease inhibitor added to the reaction mixture to create a 1:1 wt. % adduct:free urease inhibitor product (as measured by phosphorous content). In yet a further embodiment, the reaction mixture is reacted to create a weight ratio of adduct:free urease inhibitor product in the range from about 4:1 to 1:4 (as measured by phosphorous content), including 3:1 to 1:3, 2:1 to 1:2, and a 1:1. Accordingly, in some embodiments, the method of producing an adduct as described herein further comprises monitoring the amount of free urease inhibitor remaining over the course of the reaction and evaluating the completeness of reaction based on the amount of free urease inhibitor in comparison to the desired maximum content of free urease inhibitor by weight to be included in the reaction product.

It is noted that the particular reaction components may affect the reaction conditions required to produce the reaction product. For example, reaction of components in one solvent may be more efficient than reaction of those components in a different solvent and it is understood that, accordingly, less time and/or lower temperature may be required for adduct formation in the former case. Also, where a catalyst is employed, less time and/or lower temperature may be required for adduct formation. It is also noted that, in some embodiments, employing different reaction conditions can have an effect on the amount and/or type(s) of various adducts formed during the reaction.

The reaction products provided according to the methods referenced hereinabove can comprise one or a plurality of structurally different adducts. For example, a given reaction product can comprise at least one adduct, at least two different adducts, at least three different adducts, at least four different adducts, at least five different adducts, at least ten different adducts, at least twenty-five different adducts, at least about fifty different adducts, or at least about one hundred different adducts. The adducts may be in the form of discrete compounds, oligomers, polymers, and combinations thereof. The overall amount of adduct formed can vary and, likewise, the amount of each different adduct (where more than one adduct is present in the composition) can vary.

Certain specific adducts that have been identified in reaction products based on reactions between urea, formaldehyde, and NBPT, are as follows (wherein the reference to these adducts as “Adduct 1,” “Adduct 2,” and “Adduct 3” are arbitrary names chosen to distinguish them from one another and from other adducts that may be present in various reaction products):

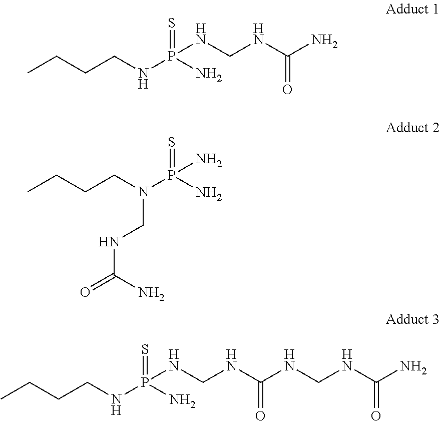 [SMILES: CCCCNP(N)(=S)NCNC(N)=O ; CCCCN(CNC(N)=O)P(N)(N)=S ; CCCCNP(N)(=S)NCNC(=O)NCNC(N)=O]

Further, one or more adduct dimers based on the reaction between NBPT, urea and formaldehyde have been identified, wherein the one or more adduct dimers are represented by the following structure:

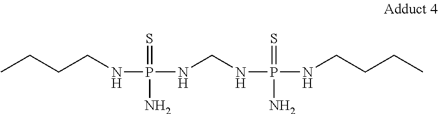 [SMILES: CCCCNP(N)(=S)NCNP(N)(=S)NCCCC]

The reaction product can comprise various other components in addition to the adduct(s). It is to be understood that other components that may be present in the reaction product can be a result of the specific method used to produce the reaction product and, particularly, of the amount of each reactant included in the reaction mixture. For example, where the reaction conditions are such that there is an excess of one or two reactants, the reaction product may comprise free reactant (i.e., reactant which is not incorporated into an adduct). In various embodiments, the reaction product can comprise at least some percent by weight of one or more components selected from the group consisting of free urease inhibitor (e.g., free NBPT), free aldehyde (e.g., free formaldehyde), free urea, free urea-aldehyde products (e.g., free urea-formaldehyde products, e.g., UFP), catalyst (e.g., MAP, DAP, or AMS), impurities (e.g., arising from the grade of reactants used), solvent, water, and combinations thereof. The relative amounts of such components can vary, with exemplary amounts and ratios disclosed below.

The reaction products can include widely varying mole percentages of urea, aldehyde, and urease inhibitor (including complexed and free forms of each component, e.g., as determined by elemental analysis). Similarly, the reaction products disclosed herein can have widely varying molar ratios, particularly as the method of producing the adducts can vary. In some specific embodiments, the reaction products have a molar ratio of about 1:0.5 to about 1:2 urease inhibitor:urea (including complexed and free forms of each component, e.g., as determined by elemental analysis). In certain embodiments, urea is used in great excess with respect to the urease inhibitor; consequently, in such embodiments, the molar ratio of urease inhibitor: urea is significantly lower. In some specific embodiments, the reaction products can have a molar ratio of about 1:0.5 to about 1:2 urease inhibitor:aldehyde (including complexed and free forms of each component, e.g., as determined by elemental analysis). Again, in some embodiments, the aldehyde is present in significant excess with respect to the urease inhibitor and, in such embodiments, the molar ratio of urease inhibitor: aldehyde is significantly lower.

### Methods of Enhancing Stability of Urease Inhibitors

As referenced hereinabove, the modification of a free urease inhibitor to provide it in the form of a reaction product comprising one or more urease inhibitor adducts as disclosed herein above has been found to “protect” the urease inhibitor by slowing or preventing degradation (e.g., hydrolytic degradation) of the urease inhibitor. In certain such adducts, under hydrolysis conditions, other reactions preferentially occur within the adduct (other than within the structure of the urease inhibitor itself). Such reactions may, in some embodiments, release the urease inhibitor from the adduct, providing the urease inhibitor in its free form (or an alternative “protected” form). For example, depending upon the structure of the urease inhibitor adduct, hydrolysis can lead to cleavage of bonds between the urease inhibitor and urea structures, between the urease inhibitor and aldehyde structures, and/or between bonds within the urea portion of the adduct, and/or bonds within the aldehyde portion of the adduct.

In one particular example, although not intending to be limited by theory, it is believed that certain adducts formed from NBPT and urea can undergo hydrolysis to break the methylene bridge therein, releasing NBPT and methylolated urea (which can further degrade into urea). Various reactions (e.g., hydrolysis reactions) are envisioned, depending on the specific structure of the adduct(s) present within a given composition, which can lead to the release of the urease inhibitor therefrom.

As such, methods are provided herein for enhancing the stability (e.g., shelf stability and in-situ stability) of a urease inhibitor-containing composition by providing it in adduct form as detailed herein. Further, methods for extending the overall release time of a given quantity of urease inhibitor are provided. As described in detail herein above, the inclusion of a urease inhibitor in the form of a reaction product between that urease inhibitor and one or both of urea and an aldehyde can provide a protected form of the urease inhibitor, serving to enhance the stability of the urease inhibitor, and/or decrease the rate of urease inhibitor degradation.

Such methods can employ various forms of the aforementioned “protected” urease inhibitors. For example, a reaction product as disclosed herein can be directly used to provide the noted effects on urease inhibitor stability and release properties. In another embodiment, the methods employ a more purified form of the reaction product as disclosed herein, which comprises one or more isolated adducts (provided by treating the reaction product so as to isolate one or more adducts therefrom and then using the resulting isolate). For example, the reaction product can be treated so as to remove any or all components other than the adducts from the reaction product to obtain a mixture comprising all adducts, a mixture comprising some adducts, or one or more single, isolated adducts. Such isolated mixtures or single adducts can be provided in their natural forms (e.g., in solid or liquid, substantially pure form) or can be treated e.g., to provide a solution or suspension/dispersion of the adduct or adducts by adding one or more solvents thereto, or to provide an adduct or adduct mixture in solid form by contacting the adduct or adduct mixture in solid, undiluted liquid, solution, or suspension/dispersion form with a solid support.

The disclosed method can involve combining the reaction product (as-formed, or modified as noted above) or the isolated adduct(s) (as-provided, or modified as noted above) with one or more other components, providing a composition wherein the urease inhibitor is, at least in part, in the protected adduct form disclosed herein. For example, for certain applications, the reaction product is admixed with one or more other components, e.g., one or more nitrogen sources (e.g., urea or a urea formaldehyde product) or free urease inhibitor. For certain applications, the one or more isolated adducts are admixed with one or more other components, e.g., one or more nitrogen sources (e.g., urea or a urea formaldehyde product) or free urease inhibitor. Again, any of these combinations can be in varying forms (e.g., in solid form, undiluted liquid form, solution form, dispersion/suspension form, and the like).

The methods of enhancing the stability of urease inhibitors disclosed herein are broadly applicable and can be effective in the context of various urease inhibitor adduct-containing compositions. For example, a reaction product can be provided that comprises a significant free urea content and/or a significant urea-formaldehyde product content, and the reaction product (in varying physical forms, e.g., as described above) can be employed as a fertilizer composition, to provide enhanced urease inhibitor stability (under storage conditions and/or under as-applied conditions (e.g., on/in the soil to which it is applied). For example, although not intending to be limited, reaction products comprising at least about 90% urea, at least about 95% urea, at least about 98% urea, or at least about 99% urea can be used as fertilizer compositions. As the reaction products can contain varying amounts of urea and/or urea-formaldehyde product, the amount of the reaction product to be applied as a fertilizer composition can vary accordingly. The rate at which such compositions are applied to soil may, in some embodiments, be identical to the rate at which urea is currently used for a given application or can be scaled accordingly (e.g., based on the weight percent of urea contained within the reaction product).

A reaction product comprising a high concentration of urea can broadly be used in all agricultural applications in which urea is currently used. These applications include a very wide range of crop and turf species, tillage systems, and fertilizer placement methods. The compositions disclosed herein are useful for fertilizing a wide variety of seeds and plants, including seeds used to grow crops for human consumption, for silage, or for other agricultural uses. Indeed, virtually any seed or plant can be treated in accordance with the present invention using the compositions of the present invention, such as cereals, vegetables, ornamentals, conifers, coffee, turf grasses, forages and fruits, including citrus. Plants that can be treated include grains such as barley, oats and corn, sunflower, sugar beets, rape, safflower, flax, canary grass, tomatoes, cotton seed, peanuts, soybean, wheat, rice, alfalfa, sorghum, bean, sugar cane, broccoli, cabbage and carrot. Application of a reaction product containing a significant urea concentration to soil and/or plants can increase the nitrogen uptake by plants, enhance crop yields, and minimize the loss of nitrogen from the soil, while providing for enhanced urease inhibitor stability as referenced herein above.

Although not limited thereto, the disclosed methods of enhancing urease inhibitor stability can be particularly useful in fertilizing and inhibiting urease under acidic conditions, e.g., in acidic soils (i.e., soils with a pH<7). It is generally understood that acidic soil degrades NBPT; however, the presently disclosed reaction products have been shown to perform well in acidic soil (e.g., better than urea-based fertilizer combined with an equivalent amount of free NBPT).

In some embodiments, the reaction product is used (in varying forms, e.g., as described above, including in isolated adduct form) in combination with one or more fertilizer compositions to provide a composition exhibiting enhanced urease inhibitor stability (under storage conditions and/or under as-applied conditions (e.g., on/in the soil to which it is applied)).

Such methods are applicable both for reaction products comprising a significant urea concentration and reaction products comprising a lower urea concentration (including reaction products comprising little to no free urea). For example, the reaction product can be applied to the soil before, concurrently with, or after application of a nitrogen-based fertilizer composition. The reaction product can be combined with the fertilizer composition, e.g., within the soil, on or about the surface of the soil, or a combination thereof. The urea can include any of the types of urea disclosed hereinabove, such as free urea, urea-formaldehyde products, urea ammonium nitrate, and the like and additionally can include various substituted ureas. Another suitable urea source can be or can include animal waste(s) such as urine and/or manure produced by one or more animals, e.g., cows, sheep, chickens, buffalo, turkeys, goats, pigs, horses, and the like.

In some embodiments, the urea source can be or can include animal waste such as urine and/or manure deposited on and/or in the soil or the nitrogen source can be or can include a fertilizer product previously applied to the soil. As such, the reaction product can be applied to the soil and mixed with the animal waste and/or previously applied fertilizer(s) on the surface of and/or within the soil. The reaction product can be applied to the soil before, during, and/or after the animal waste and/or fertilizer(s) are deposited on/in the soil. In another example, the urea source can be or can include animal waste such as urine and/or manure that can be collected and placed within a holding tank, pond, or the like, and the reaction product can be added to the animal waste to provide a mixture. The resulting mixture can then be deposited about the soil to act as a fertilizer therein.

The unique enhanced urease inhibitor stability obtained by providing the urease inhibitor in adduct form as disclosed herein can be observed in a range of compositions, and a wide range of other optional components can be included within the urease inhibitor adduct-containing compositions referenced herein. Examples of other such components include but are not limited to: nitrification inhibitors; conditioners; xanthan gum; calcium carbonate (agricultural lime) in its various forms for adding weight and/or raising the pH of acidic soils; metal containing compounds and minerals such as gypsum, metal silicates, and chelates of various micronutrient metals such as iron, zinc and manganese; talc; elemental sulfur; activated carbon, which may act as a “safener” to protect against potentially harmful chemicals in the soil; plant protectants; nutrients; nutrient stabilizers; super absorbent polymers; wicking agents; wetting agents; plant stimulants to accelerate growth; inorganic nitrogen, phosphorus, potassium (N-P-K) type fertilizers; sources of phosphorus; sources of potassium; organic fertilizers; surfactants, such as alkylaryl polyether alcohols; initiators; stabilizers; cross linkers; antioxidants; UV stabilizers; reducing agents; dyes, such as blue dye (FD & C blue #1); pesticides; herbicides; fungicides; and plasticizers. The content of the additional component(s) disclosed herein can be from about 1 to about 75 percent by weight of the composition and depends, in part, on the desired function of the additional component(s) and the makeup of the composition to which the additional component(s) are added.

Examples of conditioners include but are not limited to tricalcium phosphate, sodium bicarbonate, sodium ferricyanide, potassium ferricyanide, bone phosphate, sodium silicate, silicon dioxide, calcium silicate, talcum powder, bentonite, calcium aluminum silicate, stearic acid, and polyacrylate powder. Examples of plant protectants and nutrient stabilizers include silicon dioxide and the like. Examples of nutrients include, but are not limited to, phosphorus and potassium based nutrients. A commercially available fertilizer nutrient can include, for example, K-Fol 0-40-53, which is a solution that contains 40 wt. % phosphate and 53 wt. % potassium, which is manufactured and distributed by GBS Biosciences, LLC.

Nitrification inhibitors are compounds which inhibit the conversion of ammonium to nitrate and reduce nitrogen losses in the soil. Examples of nitrification inhibitors include, but are not limited to, dicyandiamide (DCD), and the like. Although the compositions disclosed herein can include DCD, in certain embodiments, the compositions are substantially free of DCD. “Substantially free” means that either no DCD can be detected in the mixture or, if DCD can be detected, it is (1) present in <1% w/w (preferably, <0.85% w/w, <0.80% w/w, or <0.75% w/w); and (2) does not produce effects characteristic of DCD at higher proportions. For example, a composition substantially free of DCD would not produce the environmental effects of exposure to concentrated or pure DCD even if a trace amount of DCD could be detected in the mixture. Certain exemplary compositions can have a DCD content of less than about 0.85% by weight, less than about 0.80% by weight, less than about 0.75% by weight, less than about 0.5% by weight, or less than about 0.25% by weight.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

### Example 1: Synthetic Preparation of NBPT Adducts

To a solution of NBPT (5.0 g, 29.90 mmol) in N-methylpyrrolidone (NMP, 25 mL), was added to ACS-grade urea (1.79 g, 29.90 mmol, 1 equiv), followed by formalin (50%, 795 μL, 29.90 mmol, 1 equiv) at room temperature. The reaction mixture was stirred for 24 h. A homogeneous solution was obtained, containing ˜10% unreacted NBPT (as evaluated by HPLC) and adducts, among other species.

TABLE 1
Adduct Formation Observed With Different Reactants and Reaction Conditions

| | | Concentration | Reaction Conditions | | | NBPT |
|---|---|---|---|---|---|---|
| | | of NBPT | | Temp | Reaction | conversion |
| Run # | Reactants | (wt. %) | Solvent | (° C.) | Time (hrs) | (%, HPLC) |
| 1 | NBPT + HCHO 37% + | 15 | water | 25 | 24 | 82 |
| | ACS-U^{a} (1:1:1) | | | | | |
| 2 | NBPT + | 13 | water | 25 | 24 | 98.9 |
| | dimethylolurea (1:1) | | | | | |
| 3 | NBPT + | 13 | water | 25 | 144 | 99.9 |
| | dimethylolurea (1:1) | | | | | |
| 4 | NBPT + | 13 | water | 40 | 24 | 96 |
| | dimethylolurea (1:1) | | | | | |
| 5 | NBPT + | 9 | water | 40 | 24 | 99.2 |
| | dimethylolurea (1:4) | | | | | |
| 6 | NBPT + reg-U^{b} | 0.027 | water | 25 | 24 | <1 |
| 7 | NBPT + reg-U^{b} | 0.027 | water (MAP | 25 | 24 | 26 |
| | | | as catalyst) | | | |
| 8 | NBPT + HCHO 50% + | 15 | NMP | 25 | 24 | 67 |
| | ACS-U^{a} (1:0.5:1) | | | | | |
| 9 | NBPT + HCHO 50% + | 15 | propylene | 25 | 24 | 40 |
| | ACS-U^{a} (1:0.5:1) | | glycol | | | |
| 10 | NBPT + HCHO 50% + | 15 | propylene | 25 | 24 | 55 |
| | ACS-U^{a} (1:0.5:1) | | carbonate | | | |
| 11 | NBPT + HCHO 50% + | 15 | acetonitrile | 25 | 24 | 33 |
| | ACS-U^{a} (1:0.5:1) | | | | | |
| 12 | NBPT + HCHO 50% + | 14 | NMP | 25 | 24 | 98.7 |
| | ACS-U^{a} (1:1:2) | | | | | |
| 13 | NBPT + HCHO 50% + | 13 | NMP | 25 | 24 | 98.7 |
| | ACS-U^{a} (1:2:2) | | | | | |
| 14 | NBPT + HCHO 50% + | 15 | NMP | 25 | 24 | 90 |
| | ACS-U^{a} (1:1:1) | | | | | |
| 15 | NBPT + HCHO 50% + | 40 | NMP | 25 | 24 | 91 |
| | ACS-U^{a} (1:1:1) | | | | | |
| 16 | NBPT + HCHO 50% + | 55 | NMP | 25 | 24 | 92 |
| | ACS-U^{a} (1:1:1) | | | | | |
| 17 | NBPT + HCHO 50% + | 15 | NMP | 40 | 24 | 79 |
| | ACS-U^{a} (1:1:1) | | | | | |
| 18 | NBPT + urea | 50 | none | 25 | 24 | 80 |
| | formaldehyde | | | | | |
| | concentrate (1:1) | | | | | |
| 19 | NBPT + urea | 33 | NMP | 25 | 24 | 95 |
| | formaldehyde | | | | | |
| | concentrate (1:1) | | | | | |
| 20 | NBPT + urea | 25 | NMP (MAP as | 25 | 24 | 99 |
| | formaldehyde | | catalyst) | | | |
| | concentrate (1:1) | | | | | |
| 21 | NBPT + urea | 25 | NMP/potassium | 25 | 24 | 99.9 |
| | formaldehyde | | phosphate | | | |
| | concentrate (1:1) | | buffer pH 7 | | | |
| 22 | NBPT + urea | 13 | NMP | 25 | 24 | 99.7 |
| | formaldehyde | | | | | |
| | concentrate (1:4) | | | | | |
| 23 | NBPT + urea | 33 | NMP | 40 | 24 | ~100 |
| | formaldehyde | | | | | |
| | concentrate (1:1) | | | | | |

^{a}ACS-U is ACS-grade urea, which is determined as being formaldehyde and/or UF free.
^{b}Reg-U is commercial grade urea that contains approx. 0.4 wt. % formaldehyde as UF.

### Example 2: Analysis of Hydrolysis of NBPT Adducts at Varying pH Values

NBPT adduct-containing compositions were prepared by a method similar to that described in Example 1, with the exception that acetonitrile, rather than N-methylpyrrolidone was used as the solvent and, after <20 wt. % of free NBPT remained (based on UPLC testing), the acetonitrile was evaporated. As such, the NBPT in the “adduct-containing composition” subjected to hydrolysis according to the method of Example 2 is initially partially in adduct form and partially in free form (i.e., the composition includes both NBPT-containing adduct and free NBPT).

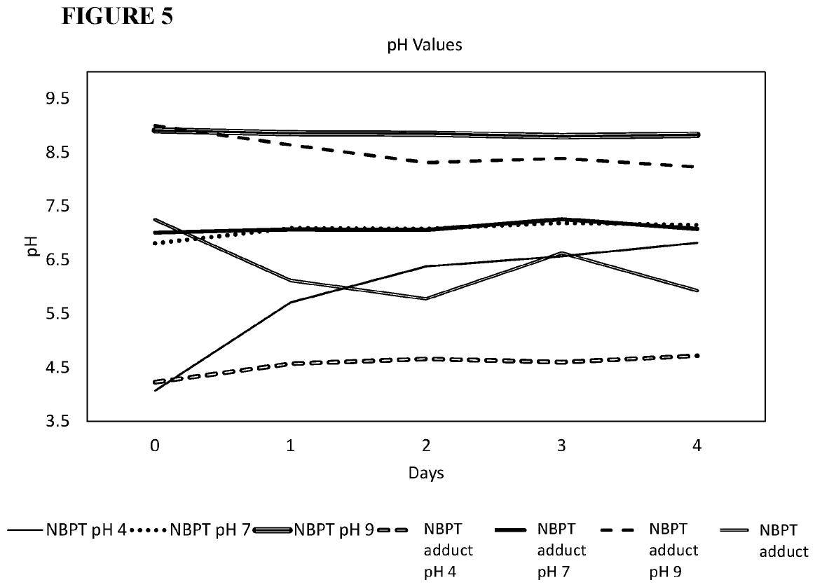

The NBPT adduct-containing compositions were hydrolyzed in accordance with OPPTS 835.2120 guidelines (https://www.regulations.gov/document?D=EPA-HQ-OPPT-2009-0152-0009), which are incorporated herein by reference. Specifically, samples comprising the NBPT adducts were subjected to various pH conditions (pH=4, pH=7, and pH=9) to evaluate the hydrolysis profiles at these varying pH values at 50° C. for 5 days. Hydrolysis of the NBPT adduct-containing compositions (by evaluating total NBPT adduct concentration as well as free NBPT concentration (i.e., NBPT in non-adduct form)) was monitored at hourly-to-daily intervals by liquid chromatography-mass spectroscopy (LC-MS), with secondary detection via ultraviolet (UV) detection at 200 nm. This monitoring provided data at varying time points under each pH condition to track the species concentration changes (believed to arise principally from hydrolysis of the NBPT). At each pH, these results were compared against the amount of free NBPT in a sample containing an equivalent amount of NBPT, all in free (non-adduct) form (shown in the Figures as “Tech. NBPT,” with values shown along the right Y axis, in ppm NBPT as measured by high performance liquid chromatography (HPLC)). The pH fluctuations over the course of these studies are shown in FIG. 5. The degradation of NBPT in the NBPT adduct-containing compositions can be compared by looking at percent degradation over time.

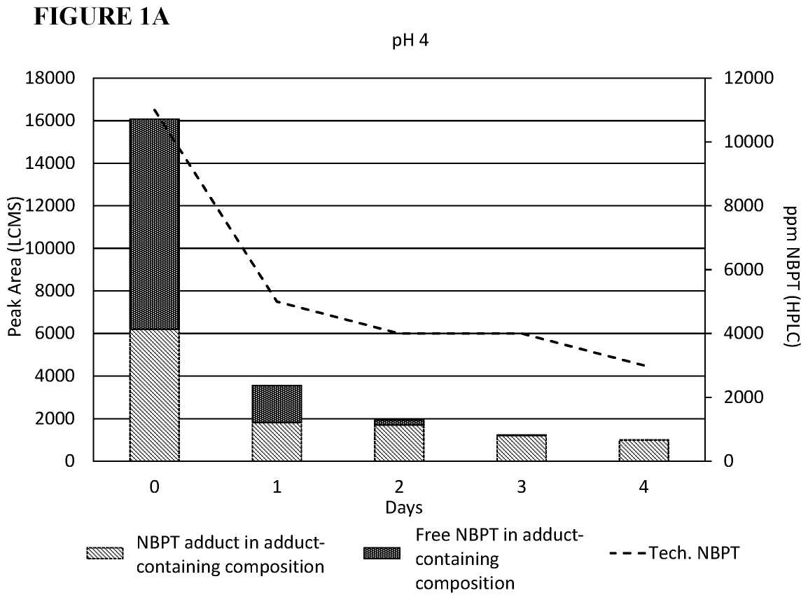

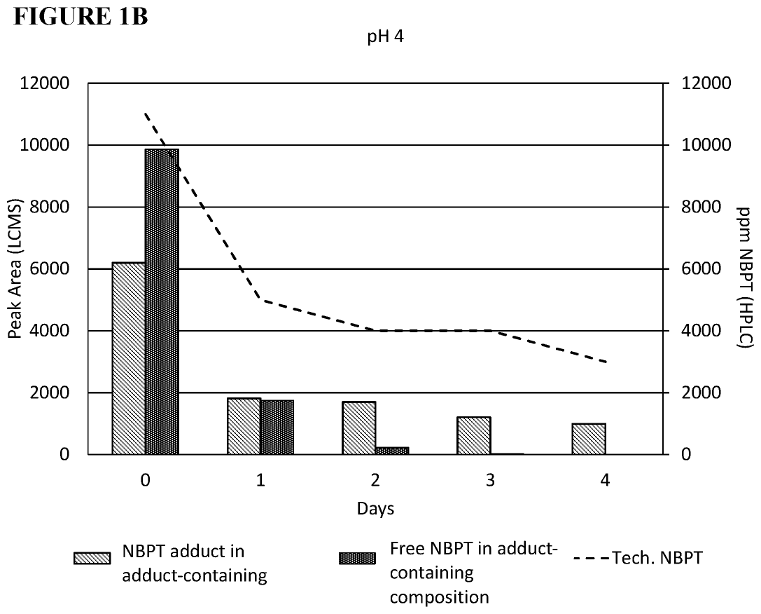

As shown in FIGS. 1A and 1B, the LCMS area of the NBPT adduct-containing composition subjected to hydrolysis conditions at an acidic pH (pH=4) at day 0 shows a greater concentration of NBPT in free form than in adduct form under acidic conditions (pH=4). The amount of free NBPT in the composition quickly decreases and is minimal at day 3 (and completely gone by day 4), whereas the amount of NBPT in adduct form does not exhibit such a dramatic decrease. Rather, the concentration of NBPT in adduct form shows a significant decrease from day 0 to day 1 (although not as significant as the decrease observed for the free NBPT in the composition) and then the concentration of NBPT in adduct form stabilizes somewhat between day 1 and 2 (with LCMS peak area of about 1800 at day 1 and about 1700 at day 2) and after a drop between day 2 and day 3, stabilizes somewhat between days 3 and 4 (with LCMS peak area of about 1200 at day 3 and about 1000 at day 4). As such, even after 4 days under acidic conditions, some NBPT remains in adduct form, although under the same conditions, no free NBPT remains in the composition.

Although not intended to be limiting, it is believed that, within the adduct, the NBPT is, in effect, “protected” for a period of time, after which hydrolysis results in cleavage of the NBPT from the remainder of the adduct structure(s) (providing “free NBPT”). Because throughout the course of this study, a portion of the NBPT in the adduct-containing composition is protected within the adduct structure, the rate of NBPT degradation generally is lower and more overall NBPT is present at later time points in the adduct-containing composition than would be expected for a comparable composition comprising only NBPT in free form, demonstrating the enhanced stability of the NBPT adduct-containing composition as compared with an analogous composition comprising only free NBPT.

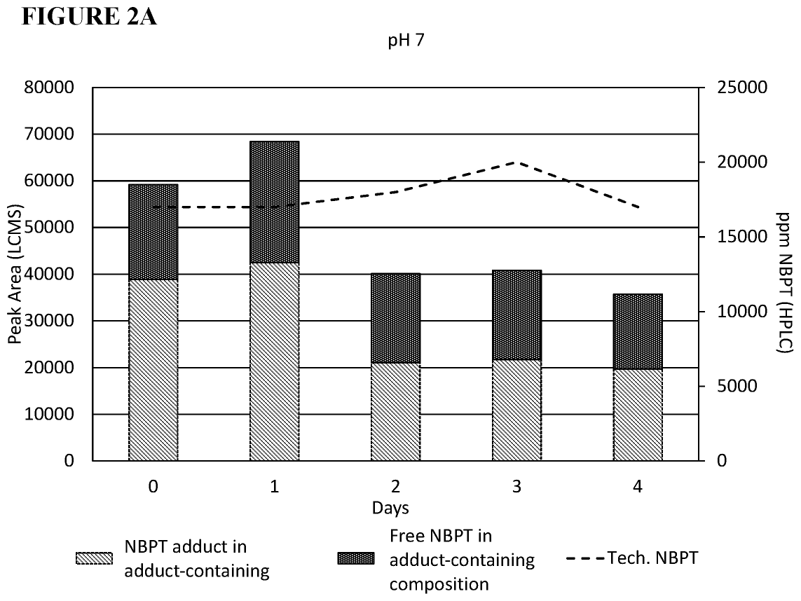

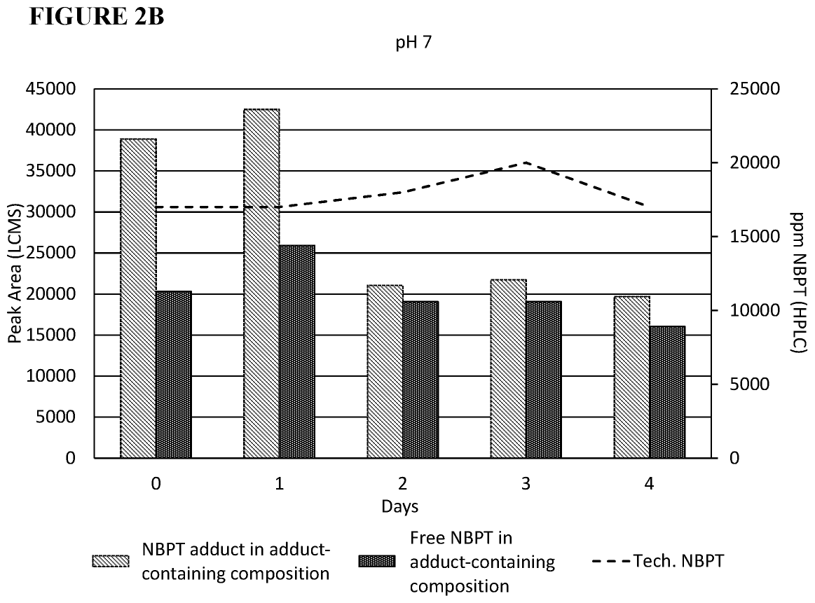

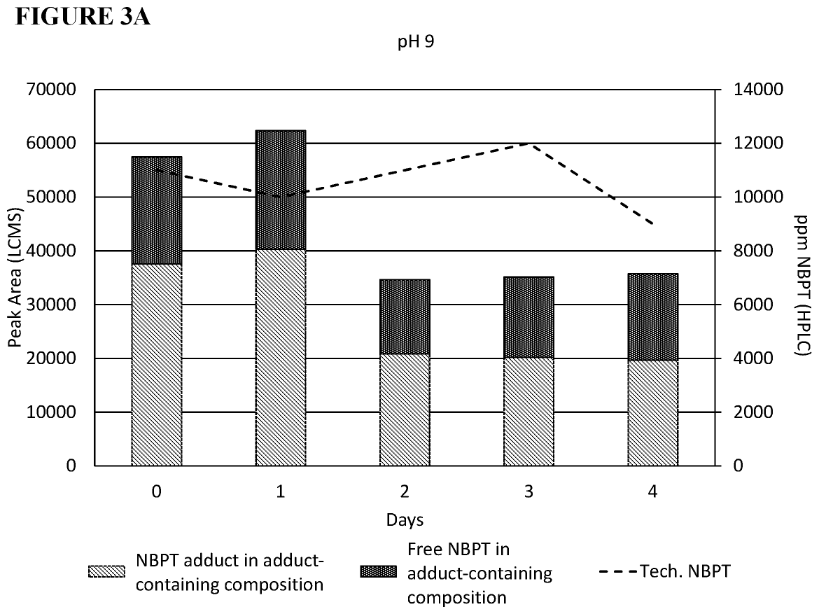

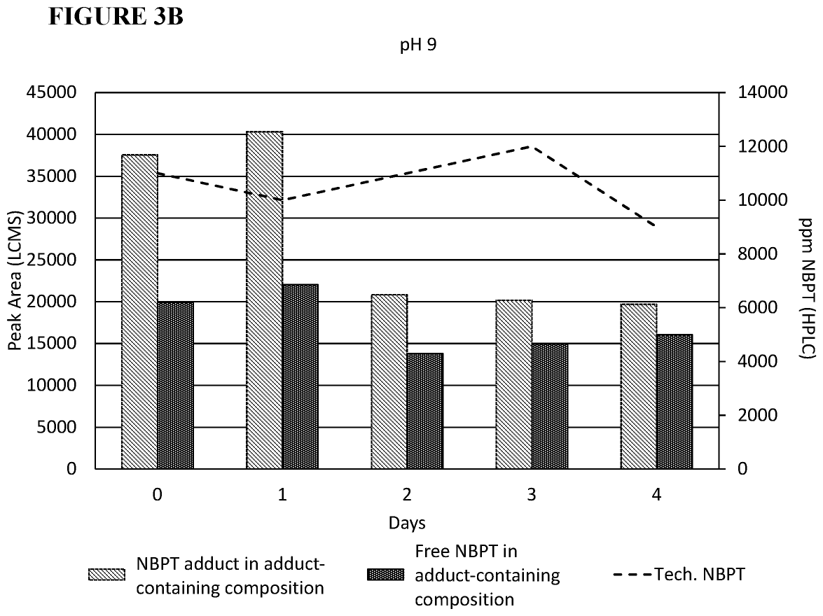

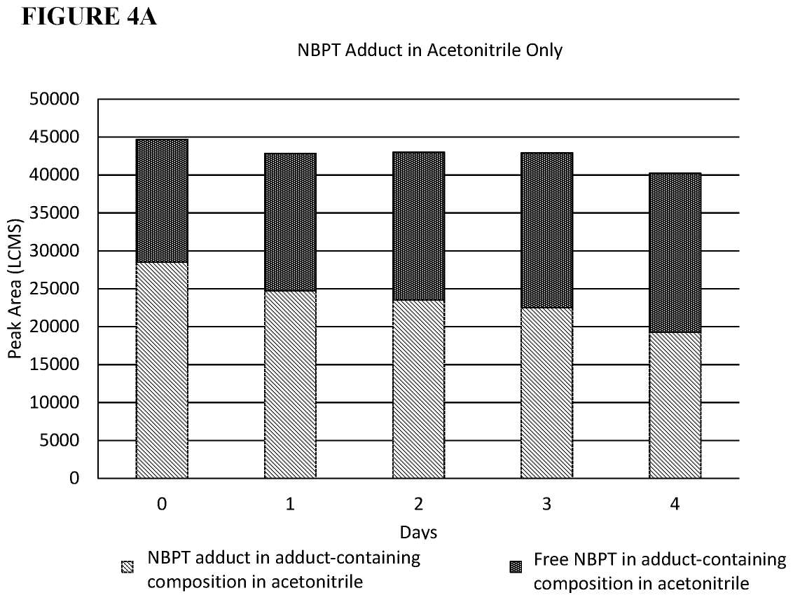

FIGS. 2A and 2B provide comparable studies, conducted under neutral conditions (at pH =7). FIGS. 3A and 3B provide comparable studies, conducted under alkaline/basic conditions (at pH=9). As shown, under neutral and basic conditions, the effect of providing NBPT in adduct form is not as pronounced as under acidic conditions. Hydrolysis occurs regardless of pH value; however, it is understood to be promoted by acid and as such, at neutral pH and basic pH, hydrolysis is not as readily detected over these short timeline studies. As such, the effect of the NBPT adduct form in protecting the NBPT from fast degradation is less pronounced under neutral conditions (pH=7) and basic conditions (e.g., pH=9) than under acidic conditions. Although this hydrolysis is not as apparent at higher pH values (e.g., under neutral and/or basic conditions, see FIGS. 2 and 3), the same phenomenon is expected to occur, although on a much longer time scale, given the decreased rate of hydrolysis under such conditions.

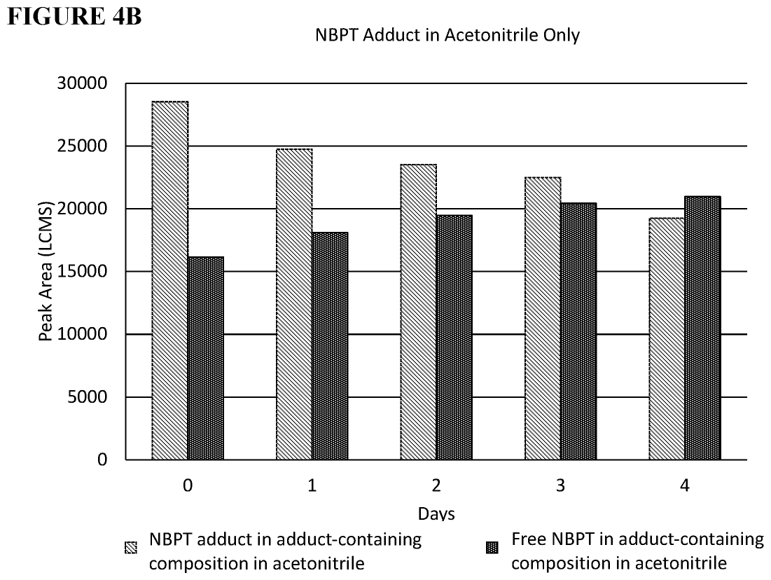

FIGS. 4A and 4B present data on a study of NBPT hydrolysis over time in acetonitrile. As shown, little change is observed over the course of the study. The overall amount of NBPT adduct slowly decreases, leading to a greater concentration of free NBPT (which is maintained in the composition). Based on this data, he NBPT adduct is understood to be slowly degrading to release free NBPT (which is not actively degraded, as it is not subjected to hydrolysis conditions as provided in the previous studies).

While the foregoing is directed to embodiments of the present invention, other and further embodiments of the invention may be devised without departing from the basic scope thereof, and the scope thereof is determined by the claims that follow.

1. A method of enhancing the stability of a urease inhibitor, comprising providing the urease inhibitor in the form of one or more adducts of the urease inhibitor with urea, formaldehyde, or both urea and formaldehyde.

2. A method of reducing the rate of degradation of a urease inhibitor, comprising providing the urease inhibitor in the form of one or more adducts of the urease inhibitor with urea, formaldehyde, or both urea and formaldehyde.

3. The method of claim 1, further comprising combining a nitrogen source with the one or more adducts to give a fertilizer composition and applying the fertilizer composition to soil, wherein the fertilizer composition exhibits slower degradation of the urease inhibitor than a comparable fertilizer composition comprising the urease inhibitor, urea, and formaldehyde in free form.

4. The method of claim 1, further comprising applying the one or more adducts to soil following application of a nitrogen source to the soil.

5. The method of claim 1, further comprising applying the one or more adducts to soil prior to application of a nitrogen source to the soil.

6. The method of claim 3, wherein the nitrogen source is selected from the group consisting of solid urea, urea ammonium nitrate, and urea formaldehyde polymer.

7. The method of claim 1, wherein the urease inhibitor is N-(n-butyl)thiophosphoric triamide (NBPT).

8. The method of claim 1, wherein the one or more adducts comprise one or more adducts represented by the following:

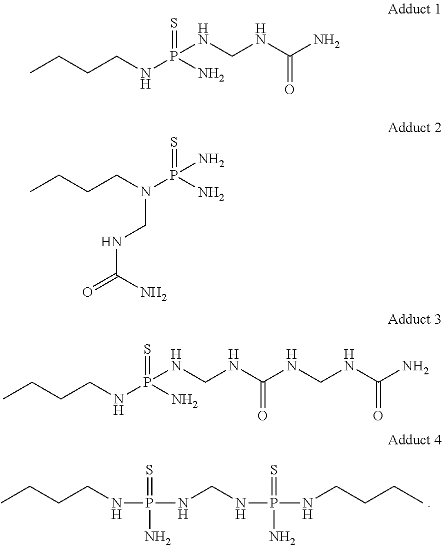 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]

9. The method of claim 3, wherein the fertilizer composition comprises substantially no dicyandiamide.

10. The method of claim 3, wherein the fertilizer composition further comprises one or more materials selected from the group consisting of free urease inhibitor, free formaldehyde, formaldehyde equivalents, urea formaldehyde polymer (UFP), water, and combinations thereof.

11. The method of claim 3, wherein the fertilizer composition comprises about 90% by weight or more urea.

12. The method of claim 3, wherein the fertilizer composition comprises about 98% by weight or more urea.

13. The method of claim 3, wherein the fertilizer composition comprises about 99% by weight or more urea.

14. The method of claim 1, wherein the soil is acidic.

15. A method of preparing a urease inhibitor-containing composition wherein the urease inhibitor exhibits enhanced stability, the method comprising: combining a urease inhibitor, urea, and formaldehyde to form an adduct of the urease inhibitor with urea, formaldehyde, or both urea and formaldehyde.

16. A method of preparing a urease inhibitor-containing composition wherein the urease inhibitor exhibits a reduced rate of degradation, the method comprising: combining a urease inhibitor, urea, and formaldehyde to form an adduct of the urease inhibitor with urea, formaldehyde, or both urea and formaldehyde.

17. The method of claim 15, further comprising combining a nitrogen source with the one or more adducts to give a fertilizer composition and applying the fertilizer composition to soil, wherein the fertilizer composition exhibits slower degradation of the urease inhibitor than a comparable fertilizer composition comprising the urease inhibitor, urea, and formaldehyde in free form.

18. The method of claim 17, wherein the nitrogen source is selected from the group consisting of solid urea, urea ammonium nitrate, and urea formaldehyde polymer.

19. The method of claim 15, wherein the urease inhibitor is N-(n-butyl)thiophosphoric triamide (NBPT).

20. The method of claim 15, wherein the one or more adducts comprise one or more adducts represented by the following: 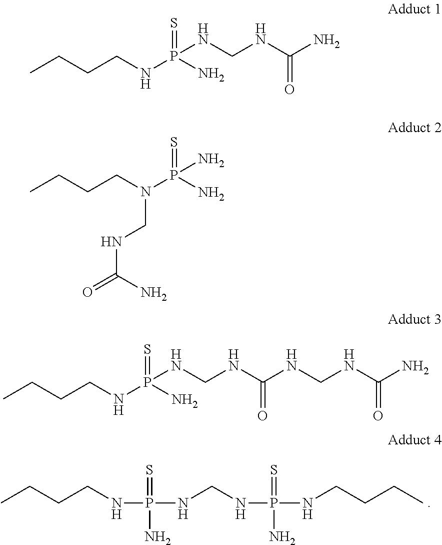 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]
